(19) United States
(12) Patent Application Publication
(10) Pub. No.: US 2014/0359599 A1
(43) Pub. Date: Dec. 4, 2014

(54) Operating System Deployment Method, Server and Electronic System

(71) Applicant: Wistron Corporation, New Taipei City (TW)

(72) Inventors: Wei-Cherng Liao, New Taipei City (TW); Chun-Yen Chang, New Taipei City (TW)

(73) Assignee: Wistron Corporation, New Taipei City (TW)

(21) Appl. No.: 14/045,790

(22) Filed: Oct. 3, 2013

(30) Foreign Application Priority Data
May 28, 2013 (TW) 102118806

(51) Int. Cl. G06F 9/445

(52) U.S. Cl. CPC G06F 8/61
USPC 717/174

(57) ABSTRACT

A method of operating system (OS) deployment for installing an OS on a plurality of electronic devices includes installing the OS on a sample electronic device; packing the OS in the sample electronic device into a prebuilt package; transmitting the prebuilt package to the plurality of electronic devices; and restoring the prebuilt package to the OS respectively in the plurality of electronic devices.

### BACKGROUND OF THE INVENTION

1. Field of the Invention

The present invention relates to an operating system deployment method and server, and more particularly, to an operating system deployment method and server capable of efficiently installing an operating system on a plurality of electronic devices.

2. Description of the Prior Art

Modern data center or cloud infrastructure generally consists of a large amount of (i.e. may be thousands of) computers, and it is time-consuming and costly to install an operating system (OS) on such large amount of computers. In the prior art, script based approaches are commonly used in unattended or remote installation of an OS on a data center or a cloud infrastructure. Before starting the installation process, an installation script is prepared in a central server. Then, the central server instructs each of the computers to install the OS step-by-step according to the installation script, whereby automation is realized and manual operation is minimized. Although the script based approaches help to save manpower, the installation time of those approaches are still considerably long. Besides, when each of the computers fetches the installation content from the central server in the installation process, the installation time may become increasing due to the processing speed limitation of the central server.

Therefore, how to improve the OS installation method so as to quickly install the OS on multiple computers has become a common goal in the industry.

### SUMMARY OF THE INVENTION

It is an objective of the present invention to provide an operating system deployment method and server capable of improving the efficiency while reducing the cost for installing an operating system on multiple electronic devices.

The present invention discloses a method of operating system (OS) deployment for installing an OS on a plurality of electronic devices. The method includes installing the OS on a disk of a sample electronic device; packing the OS in the sample electronic device into a prebuilt package; transmitting the prebuilt package to the plurality of electronic devices; and restoring the prebuilt package to the OS respectively in the plurality of electronic devices.

The present invention further discloses a server for installing an OS on a plurality of electronic devices. The server includes a processing means and a storage unit, which is coupled to the processing means and is used for storing a program code. The program code instructs the processing means to execute the steps of packing the OS in a sample electronic device into a prebuilt package; transmitting the prebuilt package to the plurality of electronic devices; and restoring the prebuilt package to the OS respectively in the plurality of electronic devices.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an electronic system according to an embodiment of the invention.

FIG. 2 is a structural diagram of a server according to an embodiment of the invention.

FIG. 3 is a flowchart of a process according to an example of the invention.

FIG. 4 is a flowchart of a process according to an example of the invention.

FIG. 5 is a flowchart of a process according to an example of the invention.

### DETAILED DESCRIPTION

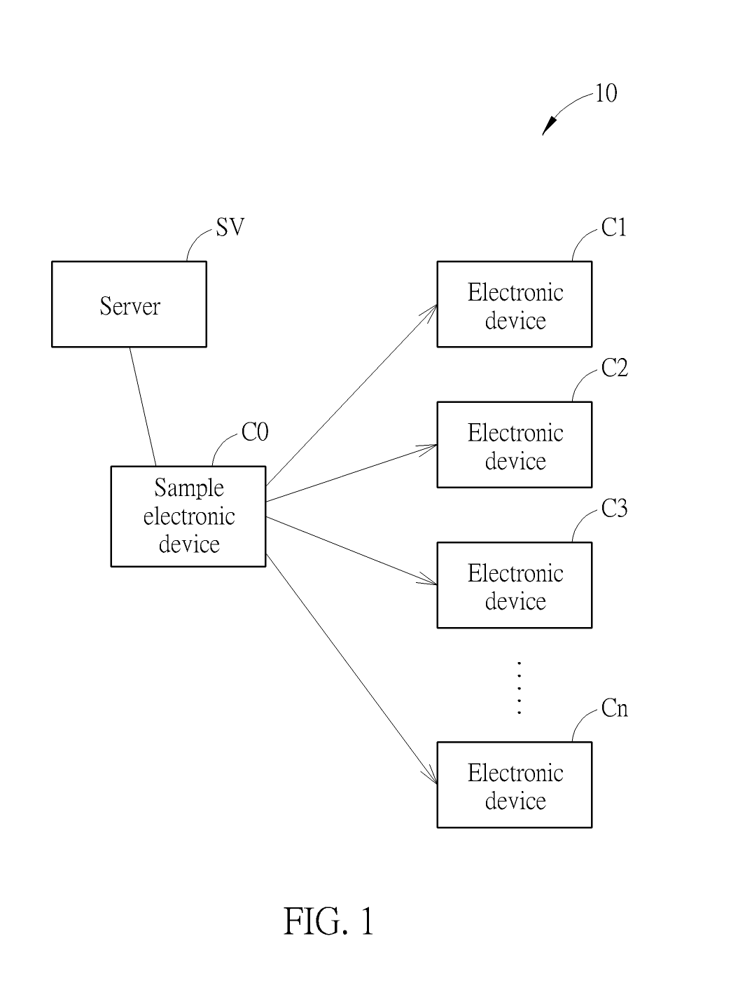

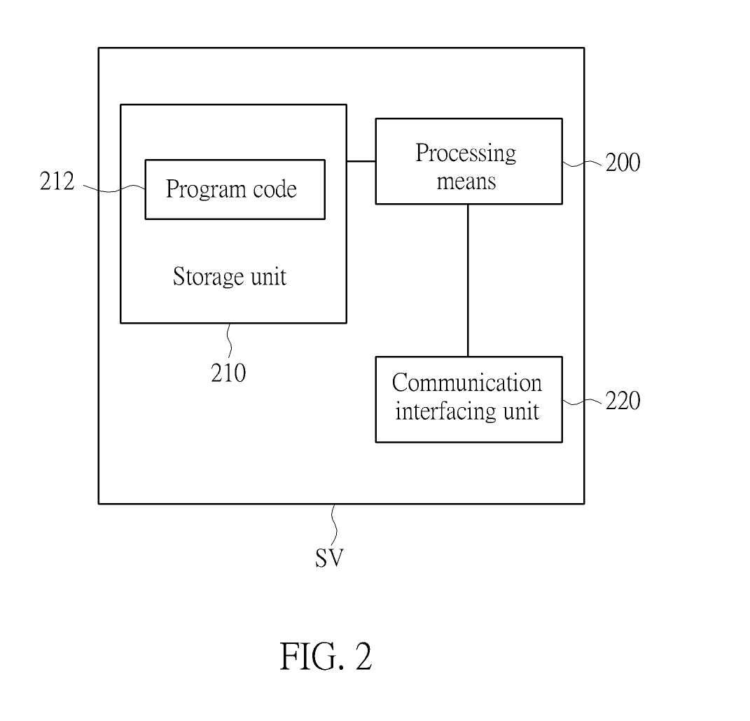

Please refer to FIG. 1, which is a schematic diagram of an electronic system 10 according to an embodiment of the invention. The electronic system 10 includes a server SV, a sample electronic device C0 and electronic devices C1-Cn, and may be used in a data center or a cloud infrastructure. Please refer to FIG. 2, which is a structural diagram of the server SV according to an embodiment of the invention. The server SV includes a processing means 200, a storage unit 210 and a communication interfacing unit 220. The processing means 200 may be a microprocessor or Application Specific Integrated Circuit (ASIC). The storage unit 210 may be any data storage device that can store a program code 212, accessed and executed by the processing means 200. Examples of the storage unit 210 include but are not limited to read-only memory (ROM), flash memory, random-access memory (RAM), CD-ROM/DVD-ROM, magnetic tape, hard disk and optical data storage device. The communication interfacing unit 220 may connect the sample electronic device C0 or the electronic devices C1-Cn for transmitting and receiving commands instructed by the processing means 200 or providing data transmission capability.

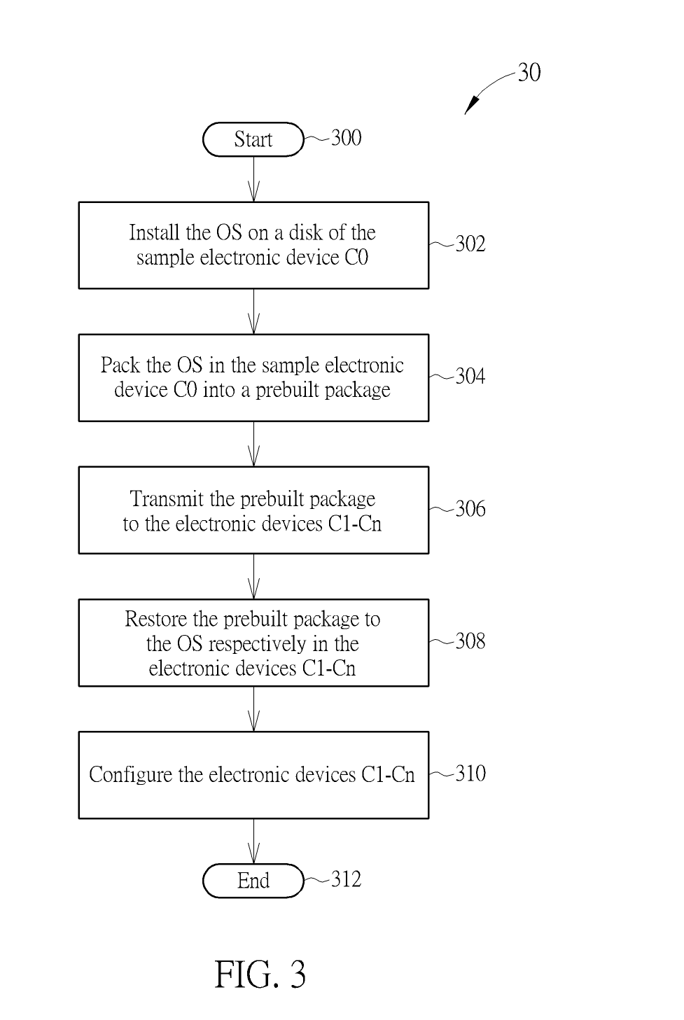

Please refer to FIG. 3, which is a flowchart of a process 30 according to an example of the invention. The process 30 may be used in the electronic system 10 shown in FIG. 1 for deploying an operating system (OS) to all electronic devices in the electronic system 10 (i.e. the sample electronic device C0 and electronic devices C1-Cn). The process 30 may be compiled into the program code 212, executed by the processing means 200 of the server SV to perform the following steps:

Step 300: Start.

Step 302: Install the OS on a disk of the sample electronic device C0.

Step 304: Pack the OS in the sample electronic device C0 into a prebuilt package.

Step 306: Transmit the prebuilt package to the electronic devices C1-Cn.

Step 308: Restore the prebuilt package to the OS respectively in the electronic devices C1-Cn.

Step 310: Configure the electronic devices C1-Cn.

Step 312: End.

According to the process 30, the server SV selects the sample electronic device C0 from a plurality of electronic devices first, and installs the OS that needs to be deployed on the disk of the sample electronic device C0. Next, the OS in the sample electronic device C0 is packed into a prebuilt package, and then the prebuilt package is transmitted to the electronic devices C1-Cn (i.e. target machines) respectively. After the electronic devices C1-Cn completely receive the prebuilt package respectively, the prebuilt package is restored to the OS in the electronic devices C1-Cn, and post-configurations such as IP address and registry configurations are performed on the electronic devices C1-Cn. In other words, the present invention sets up the OS, which needs to be deployed to the electronic devices C1-Cn, in the sample device C0 and then packs the OS into the prebuilt package. As a result, the electronic devices C1-Cn can readily and efficiently restore the prebuilt package to the OS after receiving the prebuilt package, instead of setting up the OS in each of the electronic devices C1-Cn from scratch as the approaches of the prior art. Thus, efficiency of installing the OS on the electronic devices C1-Cn may be improved, and the cost required to install the OS may be reduced.

Noticeably, the process 30 requires setting up the OS in the sample device C0, packing the OS in the sample device C0 into the prebuilt package, and then restoring the prebuilt package to the OS and performing corresponding configurations in the electronic devices C1-Cn after the electronic devices C1-Cn receive the prebuilt package, but is not limited herein. For example, after the OS is installed on the sample electronic device C0, functionalities of the OS may be verified in the sample electronic device C0, so as to confirm that the OS can be deployed to the electronic devices C1-Cn in large. In addition, when preparing to pack the OS into the prebuilt package, unnecessary content of the OS may be removed according to requirement of the electronic system 10 in order to decrease the loading of transmitting the prebuilt package. Moreover, a restore script or an auto-configuration program may be created in the prebuilt package. As such, the electronic devices C1-Cn may restore the prebuilt package to the OS according to the restore script and immediately perform the post-configurations by using the auto-configuration program.

The sample electronic device C0 and the electronic devices C1-Cn may be connected via a transmission line, a cable network, a wireless network, or the server SV in order to transmit the prebuilt package from the sample electronic device C0 to the electronic devices C1-Cn. The sample electronic device C0 may transmit the prebuilt package to the electronic devices C1-Cn via a network by using a transport layer protocol that utilizes a broadcast, a multicast or a peer-to-peer (P2P) technology. Before receiving the prebuilt package, the electronic devices C1-Cn may be launched in a manner analogous to the network boot, so as to utilize a broadcast, a multicast or a P2P technology to receive the prebuilt package.

Furthermore, methods for packing the OS into the prebuilt package are not limited. For instance, a general file compressing method such as zip, gzip, bzip, rar, tar or iso, in a file system may be adopted to pack the OS into the prebuilt package. Before packing the OS, the server SV or the sample electronic device C0 may determine if the OS supports the file system, and pack the OS accordingly. If the determination result shows that the OS does not support the file system, the OS may be packed by cloning the entire content of the disk of the sample electronic device C0 to another disk in a sector-to-sector manner. Namely, in such a case the prebuilt package is formed by cloning all the data in the sectors that store the OS in the sample electronic device C0 to other sectors.

On the other hand, after any electronic device Cx of the electronic devices C1-Cn receives the prebuilt package, the electronic device Cx may determine if the prebuilt package is in a form of a file system, and then restore the prebuilt package to the OS according to a decompressing procedure of the file system. The electronic device Cx may proceed with the steps such creating a boot loader and performing configurations to the OS in the electronic device Cx. If the prebuilt package is not in a form of a file system, the electronic device Cx clones the prebuilt package to a disk of the electronic device Cx in a sector-to-sector manner in order to form the OS.

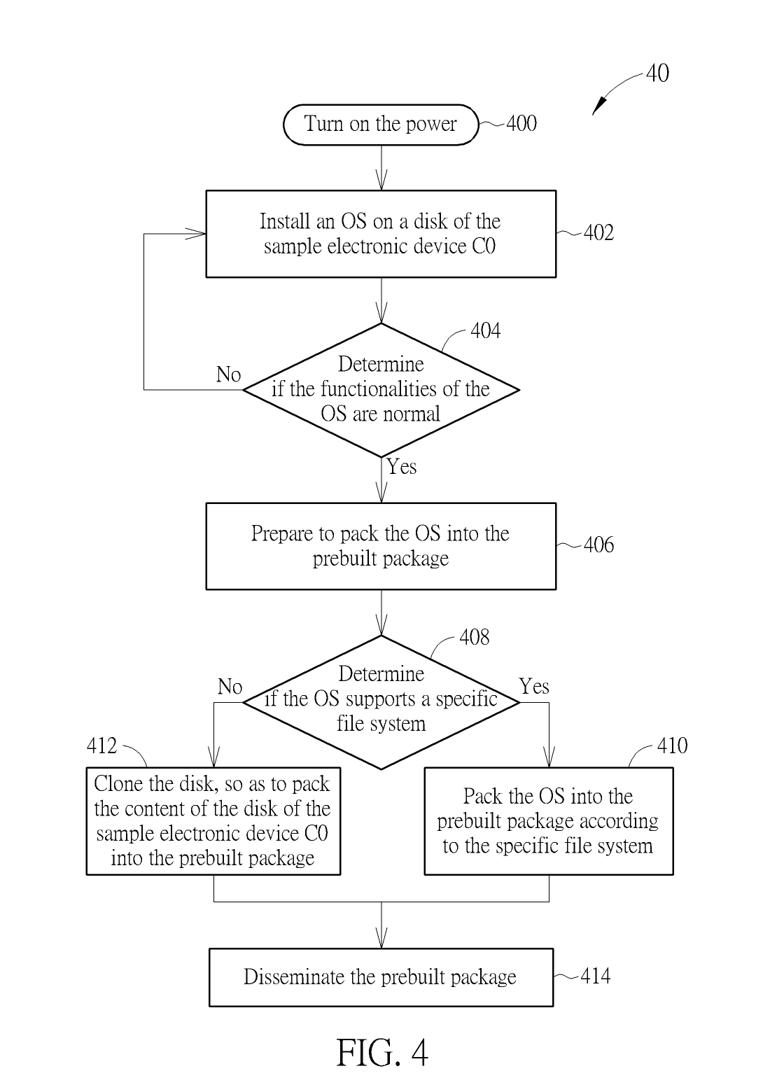

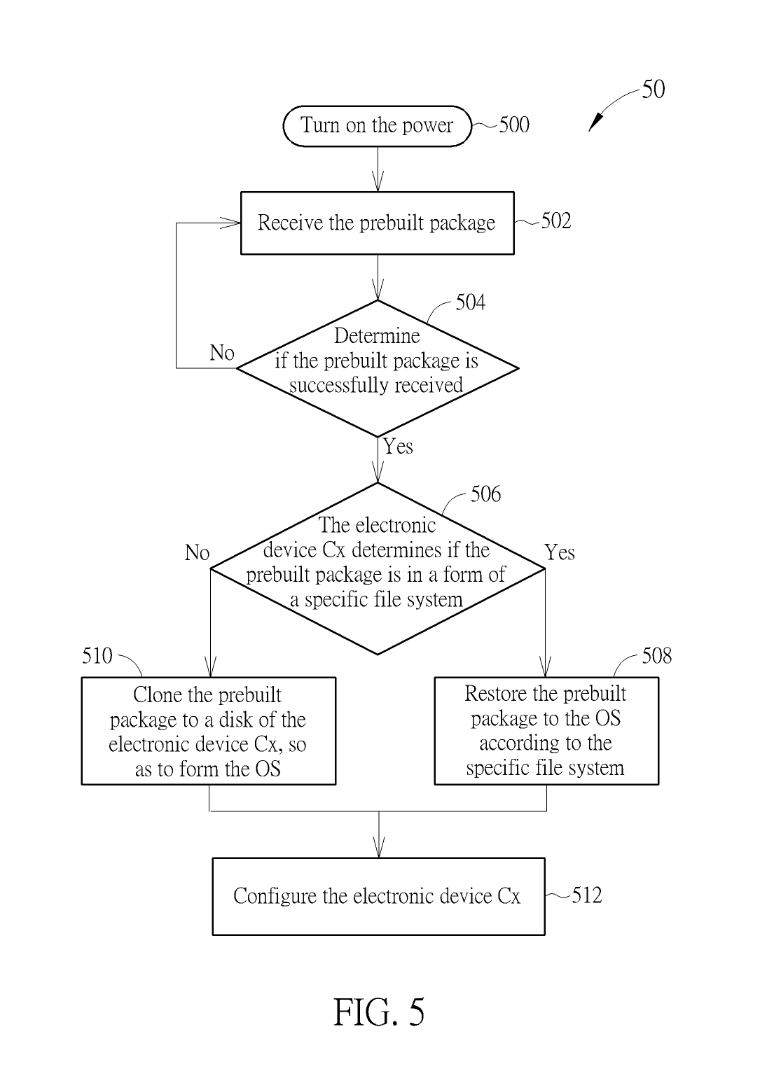

Operations and flows pertaining to the sample electronic device C0 and electronic devices C1-Cn mentioned above are summarized into processes 40 and 50, as shown in FIG. 4 and FIG. 5, respectively. The process 40 may be used in the sample electronic device C0 of the electronic system 10, and includes the following steps:

Step 400: Turn on the power.

Step 402: Install an OS on a disk of the sample electronic device C0.

Step 404: Determine if the functionalities of the OS are normal. If yes, go to Step 406; otherwise, back to Step 402.

Step 406: Prepare to pack the OS into the prebuilt package.

Step 408: Determine if the OS supports a specific file system. If yes, go to Step 410; otherwise, go to Step 412.

Step 410: Pack the OS into the prebuilt package according to the file system. Go to Step 414.

Step 412: Clone the disk, so as to pack the content of the disk of the sample electronic device C0 into the prebuilt package.

Step 414: Disseminate the prebuilt package.

On the other hand, the process 50 may be used in the electronic devices C1-Cn of the electronic system 10 (e.g. the electronic device Cx), and includes the following steps:

Step 500: Turn on the power.

Step 502: Receive the prebuilt package.

Step 504: Determine if the prebuilt package is successfully received. If yes, go to Step 506; otherwise, back to Step 502.

Step 506: The electronic device Cx determines if the prebuilt package is in a form of a specific file system. If yes, go to Step 508; otherwise, go to Step 510.

Step 508: Restore the prebuilt package to the OS according to the specific file system. Go to Step 512.

Step 510: Clone the prebuilt package to a disk of the electronic device Cx, so as to form the OS.

Step 512: Configure the electronic device Cx.

Please refer to the aforementioned for elaborated descriptions, related modifications and/or alterations of the processes 40 and 50.

To sum up, in the prior art, script based approaches are used for deploying an OS. An installation script is prepared in a central server, and then the central server instructs each of the electronic devices to perform the installation process step-by-step according to the installation script. Thus, the installation process of the prior art is considerably time-consuming. On the contrary, the present invention sets up the OS to be deployed in the sample electronic device beforehand, and packs the OS that completes the setup process into the prebuilt package. Therefore, after the electronic devices C1-Cn receive the prebuilt package, the prebuilt package can be readily and rapidly restored to the OS in each of the electronic devices C1-Cn, so as to improve the efficiency and reduce the cost of installing the OS on a large amount of electronic devices.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of operating system (OS) deployment for installing an OS on a plurality of electronic devices, comprising:
installing the OS on a disk of a sample electronic device;
packing the OS in the sample electronic device into a prebuilt package;
transmitting the prebuilt package to the plurality of electronic devices; and
restoring the prebuilt package to the OS respectively in the plurality of electronic devices.

2. The method of claim 1, further comprising:
configuring the plurality of electronic devices after the prebuilt package is restored to the OS respectively in the plurality of electronic devices.

3. The method of claim 2, wherein the prebuilt package comprises an auto configuration program used for configuring the plurality of electronic devices.

4. The method of claim 1, wherein the step of packing the OS in the sample electronic device into the prebuilt package comprises:
determining if the OS supports a file system and generating a determination result; and
packing the OS in the sample electronic device into the prebuilt package according to the determination result.

5. The method of claim 4, wherein the step of packing the OS in the sample electronic device into the prebuilt package according to the determination result comprises:
packing the OS into the prebuilt package based on the file system if the determination result shows that the OS supports the file system.

6. The method of claim 4, wherein the step of packing the OS in the sample electronic device into the prebuilt package according to the determination result comprises:
packing the OS into the prebuilt package by cloning the content of the disk to another disk in a sector-to-sector manner if the determination result shows that the OS does not support the file system.

7. The method of claim 1, wherein the step of restoring the prebuilt package to the OS respectively in the plurality of electronic devices comprises:
after a first electronic device of the plurality of electronic devices obtains the prebuilt package, the first electronic device determining if the prebuilt package is in a form of a file system and generating a determination result; and
the first electronic device restoring the prebuilt package to the OS according to the determination result.

8. The method of claim 7, wherein the step of the first electronic device restoring the prebuilt package to the OS according to the determination result comprises:
the first electronic device restoring the prebuilt package to the OS according to a decompressing procedure of the file system when the determination result shows that the prebuilt package is in the form of the file system.

9. The method of claim 7, wherein the step of the first electronic device restoring the prebuilt package to the OS according to the determination result comprises:
the first electronic device cloning the prebuilt package to a disk of the first electronic device in a sector-to-sector manner when the determination result shows that the prebuilt package is not in the form of the file system.

10. The method of claim 1, wherein the step of transmitting the prebuilt package to the plurality of electronic devices comprises transmitting the prebuilt package to the plurality of electronic devices via a network by using a transport layer protocol.

11. The method of claim 10, wherein the transport layer protocol utilizes a broadcast, a multicast or a peer-to-peer (P2P) technology.

12. A server for installing an operating system (OS) on a plurality of electronic devices, comprising:
a processing means; and
a storage unit, coupled to the processing means, for storing a program code, wherein the program code instructs the processing means to execute the following steps:
packing the OS in a sample electronic device into a prebuilt package;
transmitting the prebuilt package to the plurality of electronic devices; and
restoring the prebuilt package to the OS respectively in the plurality of electronic devices.

13. The server of claim 12, further comprising:
configuring the plurality of electronic devices after the prebuilt package is restored to the OS respectively in the plurality of electronic devices.

14. The server of claim 13, wherein the prebuilt package comprises an auto configuration program used for configuring the plurality of electronic devices.

15. The server of claim 12, wherein the step of packing the OS in the sample electronic device into the prebuilt package comprises:
determining if the OS supports a file system and generating a determination result; and
packing the OS in the sample electronic device into the prebuilt package according to the determination result.

16. The server of claim 15, wherein the step of packing the OS in the sample electronic device into the prebuilt package according to the determination result comprises:
packing the OS into the prebuilt package based on the file system if the determination result shows that the OS supports the file system.

17. The server of claim 15, wherein the step of packing the OS in the sample electronic device into the prebuilt package according to the determination result comprises:
packing the OS into the prebuilt package by cloning the content of a disk of the sample electronic device to another disk in a sector-to-sector manner if the determination result shows that the OS does not support the file system.

18. The server of claim 12, wherein the step of restoring the prebuilt package to the OS respectively in the plurality of electronic devices comprises:
after a first electronic device of the plurality of electronic devices obtains the prebuilt package, the first electronic device determining if the prebuilt package is in a form of a file system and generating a determination result; and
the first electronic device restoring the prebuilt package to the OS according to the determination result.

19. The server of claim 18, wherein the step of the first electronic device restoring the prebuilt package to the OS according to the determination result comprises:
the first electronic device restoring the prebuilt package to the OS according to a decompressing procedure of the file system when the determination result shows that the prebuilt package is in the form of the file system.

20. The server of claim 18, wherein the step of the first electronic device restoring the prebuilt package to the OS according to the determination result comprises:
the first electronic device cloning the prebuilt package to a disk of the first electronic device in a sector-to-sector manner when the determination result shows that the prebuilt package is not in the form of the file system.

21. The server of claim 12, wherein the step of transmitting the prebuilt package to the plurality of electronic devices comprises transmitting the prebuilt package to the plurality of electronic devices via a network by using a transport layer protocol.

22. The server of claim 21, wherein the transport layer protocol utilizes a broadcast, a multicast or a peer-to-peer (P2P) technology.
